(19) United States
(12) Patent Application Publication
(10) Pub. No.: US 2025/0011153 A1
(43) Pub. Date: Jan. 9, 2025

(54) AUTOMATED FOUNTAIN BEVERAGE DISPENSING SYSTEM

(71) Applicants: Soykan DIRIK, Laguna Niguel, CA (US); Mehmet KAPTANA, Irvine, CA (US)

(72) Inventors: Soykan DIRIK, Laguna Niguel, CA (US); Mehmet KAPTANA, Irvine, CA (US)

(21) Appl. No.: 18/892,415

(22) Filed: Sep. 22, 2024

Related U.S. Application Data
(63) Continuation-in-part of application No. 17/721,208, filed on Apr. 14, 2022, now abandoned.
(60) Provisional application No. 63/174,771, filed on Apr. 14, 2021.

(51) Int. Cl. B67D 1/08; B25J 11/00

(52) U.S. Cl. CPC B67D 1/0878; B25J 11/0045; B67D 1/0888; B67D 2210/00076; B67D 2210/00078

(57) ABSTRACT

An automated fountain beverage dispensing system comprises a main body attachable to a beverage dispenser, a cup holding unit having a plurality of cup holders for holding cups, a first rail provided on the main body, a first slider arranged to slide on the first rail for extracting and moving a predetermined cup, a second rail provided on the main body, a second slider arranged to slide on the second rail, and a robotic arm unit mounted with the second slider for holding and moving the selected cup. The robotic arm unit is configured to fill the cup with a beverage by pressing one of the plurality levers of the beverage dispenser depending on what type of beverage is selected from a touch screen provided on the main body or via a POS system. The robotic arm unit is further configured to leave the filled cup in a predetermined position.

### CROSS REFERENCE TO THE RELATED APPLICATIONS

This application is a continuation-in-part (CIP) application of U.S. non-provisional application Ser. No. 17/721,208 filed on Apr. 14, 2022, which claims priority from U.S. provisional application No. 63/174,771 filed on Apr. 14, 2021, the entire contents of which are incorporated herein by reference.

### TECHNICAL FIELD

The present invention belongs to the field of beverage dispensing systems. More particularly, the present invention relates to an automated fountain beverage dispensing system for a beverage dispenser that simulates human movement thereby allowing automation of beverage dispensing activity.

### BACKGROUND

Automated beverage dispensing systems are known in the art—for example, U.S. Pat. No. 9,994,340 discloses an automated beverage dispenser for dispensing beverages and ice into a cup.

Beverage dispensing systems are located in the areas accessible to the crew members or the customers of a restaurant and have features like pre-determined portion control for the amount of beverage dispensed for a particular cup size. As a result, the person handling the beverage dispensing system may be: i) a crew member of the restaurant, or ii) a customers of the restaurant. Commonly, the person handling the beverage dispensing system may take an order, then manually pull a cup, may or may not add ice to the cup depending on the order, and then place the cup under the nozzle of the beverage dispensing system, which then dispenses a beverage to fill the cup as per the order at the press of a valve. Based on the type of valve present in the beverage dispensing system, the beverage is filled either manually, by the said person deciding on the amount of beverage to dispense, or automatically where the said person presses a cup-size button on the valve so that a predetermined amount of beverage is dispensed. Another popular method of automatically dispensing beverages is where the person handling the beverage dispensing system places the cup under the nozzle, the cup is filled to the top, and the valve stops dispensing the beverage upon detecting overflow. The current invention discloses a robotic arm unit that simulates all these human movements.

The current invention discloses a beverage dispensing system comprising a robotic arm unit capable of simulating human movement, whereby the said attachment is mounted on an already existing beverage dispenser, and the simulation of human movement by the said robotic arm unit allows the automation of the beverage dispensing process. The current invention disclosing only an attachment, and not a full-scale automated beverage dispenser, allows capital savings.

### SUMMARY

The invention relates to an automated fountain beverage dispensing system for a beverage dispenser, comprising a main body attachable to the beverage dispenser; a cup holding unit having a plurality of cup holders for holding cups; a first rail provided on the main body; a first slider arranged to slide on the first rail for extracting and moving a selected cup; a second rail provided on the main body; a second slider arranged to slide on the second rail; and a robotic arm unit mounted with the second slider for holding and moving the selected cup. The cup holding unit is configured to slide with respect to the first slider; the first slider is configured to slide under a selected one of the plurality of cup holders and to extract the cup from the selected one of the plurality of cup holders of the cup holding unit; the second slider is configured to slide the robotic arm unit to grab the cup extracted and conveyed by the first slider; the robotic arm unit is configured to fill the cup with a beverage by pressing one of the plurality levers of the beverage dispenser depending on what type of beverage is selected from a touch screen provided on the main body or via a POS system. T

The present invention offers the possibility of robotizing existing kitchens without any physical modifications to these areas. This allows businesses to utilize robotic technologies without additional costs or prolonged downtime while maintaining their existing kitchen infrastructure.

By enabling the automation of kitchen operations without the need to replace existing equipment and layout, this invention saves businesses significant time and cost. In addition, integrating robotic systems reduces the workload of kitchen staff, creating more efficient and safer working environments. This innovative approach increases operational efficiency for restaurants, cafes and other catering establishments, while also raising hygiene standards. As a result, this robotic transformation of existing kitchens will benefit both businesses and customers.

### BRIEF DESCRIPTION OF THE DRAWINGS

FIG. 1 is a perspective view showing an automation system mounted to a beverage dispenser according to the present invention.

FIG. 2 is a perspective view showing a cup being taken from a cup holding unit according to the present invention.

FIG. 3 is a perspective view showing the cup being taken from the cup holding unit by a first slider according to the present invention.

FIG. 4 is a perspective view showing a robotic arm unit grabbing the cup according to the present invention.

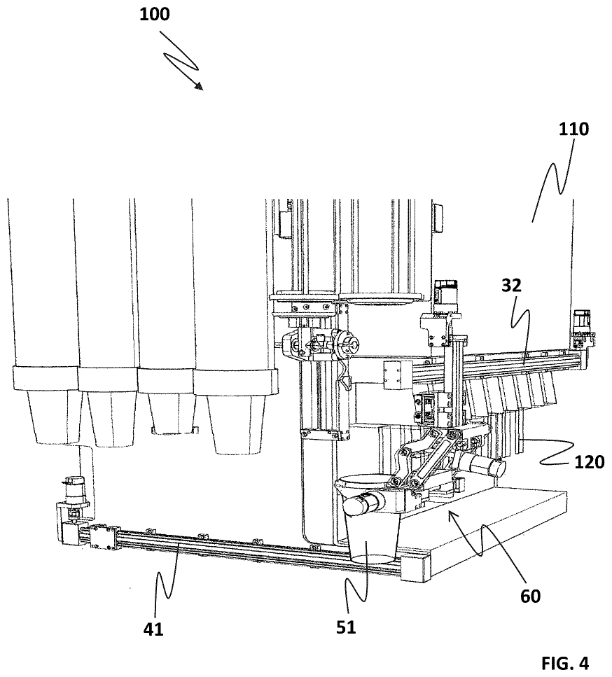

FIG. 5 is a perspective view showing the movement of the cup to fill ice by the robotic arm unit according to the present invention.

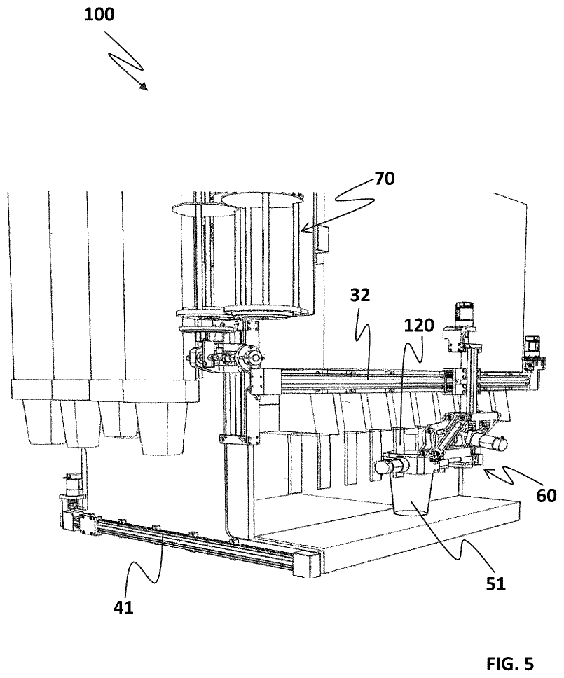

FIG. 6 is a perspective view showing the movement of the cup to fill the beverage by the robotic arm unit according to the present invention.

FIG. 7 is a perspective view showing the lid being closed according to the present invention.

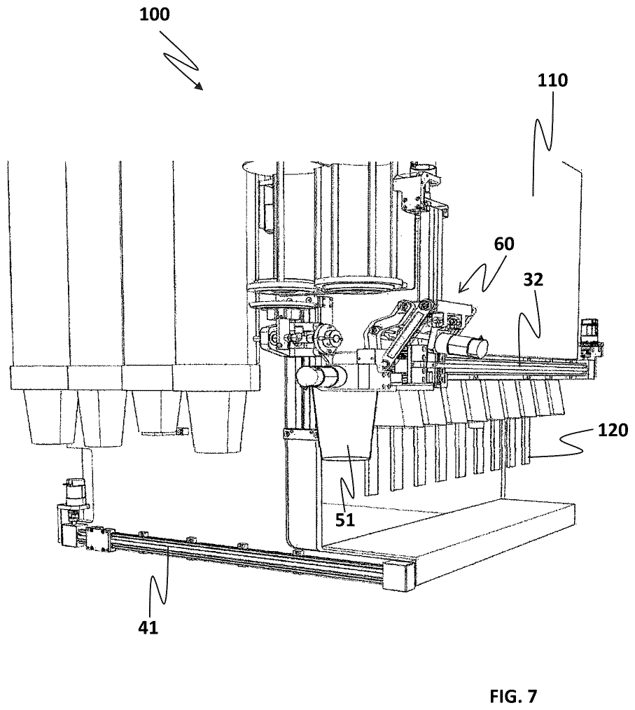

FIG. 8 is a perspective view showing the movement of the cup to a parking area according to the present invention.

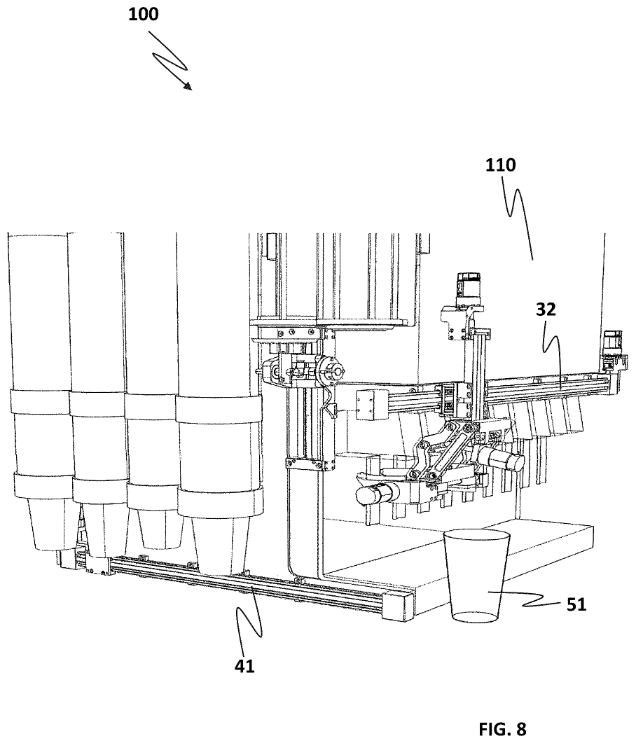

FIG. 9 is a perspective view showing multiple cups being filled simultaneously according to the present invention.

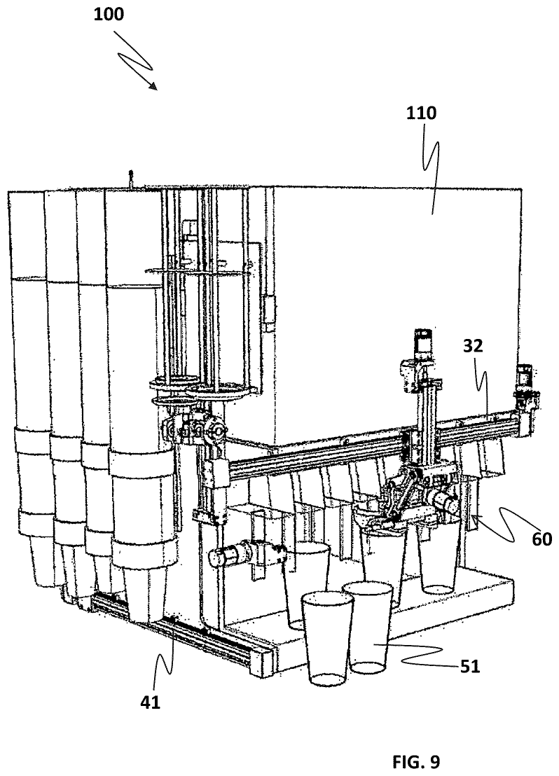

FIG. 10 is a perspective view showing an automation system according to another embodiment of the present invention.

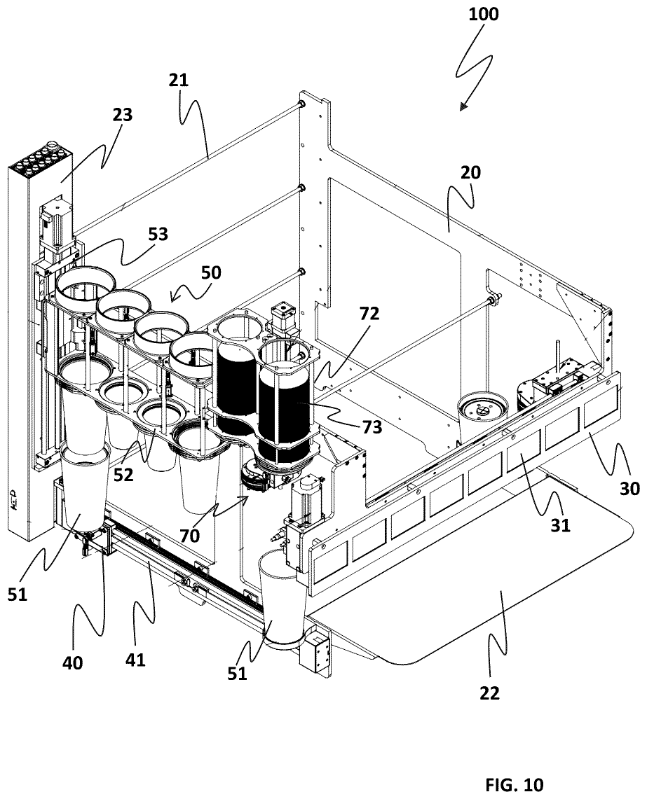

FIG. 11 is another perspective view of the automation system shown in FIG. 10 wherein the automation system has a touch screen.

FIG. 12 is a side view of the automation system shown in FIG. 10, wherein the robotic arm unit grabs the extracted and conveyed cup.

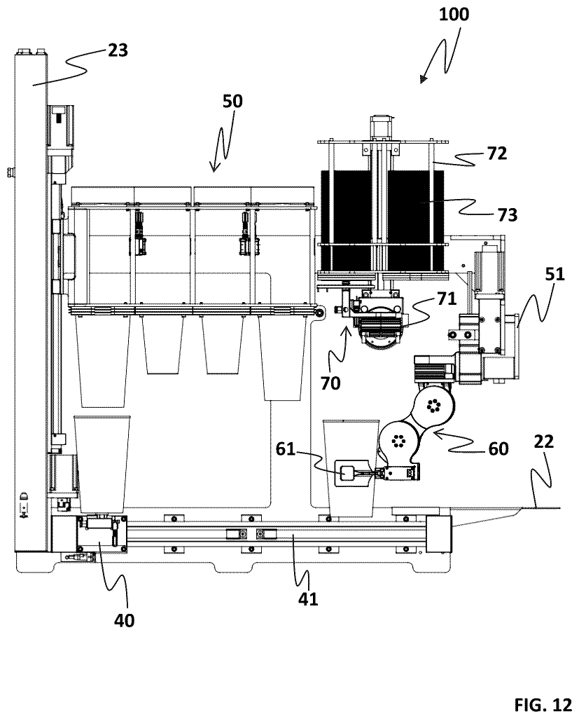

FIG. 13 is a front view of the automation system shown in FIG. 10.

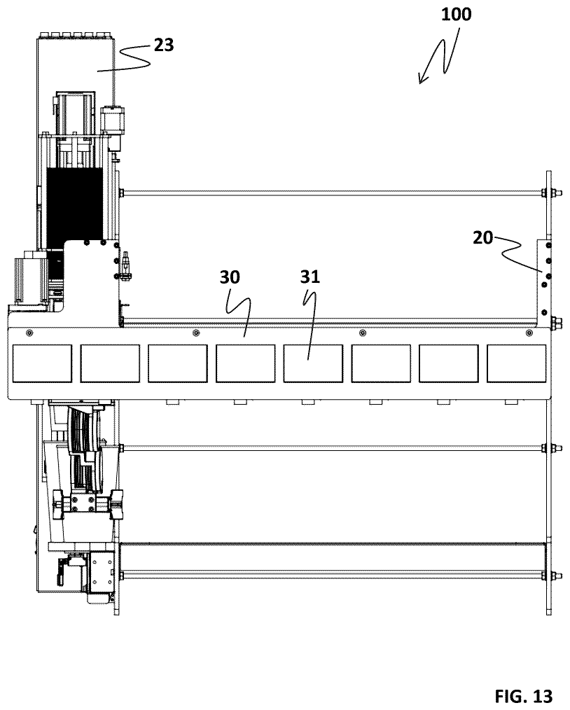

FIG. 14 is a perspective view of the robotic arm unit for the automation system according to the present invention.

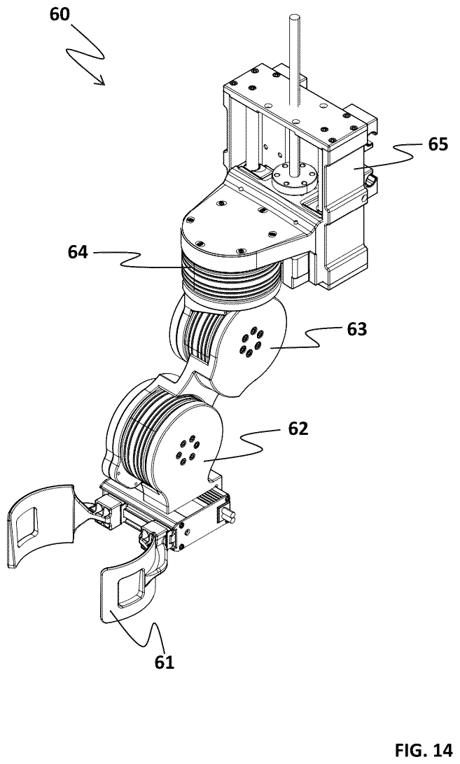

FIG. 15 is a side view of the robotic arm unit shown in FIG. 14.

FIG. 16 is a partial side view of the automation system shown in FIG. 10, wherein the predetermined cup is extracted by the first slider.

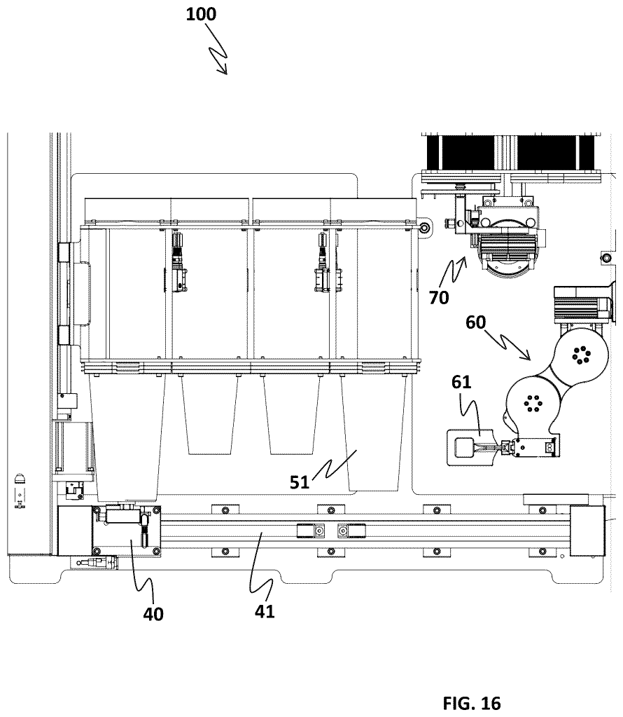

FIG. 17 is a partial side view of the automation system shown in FIG. 10, wherein the extracted cup is carried by the first slider and the robotic arm unit grabs it.

FIG. 18 is a front view of the automation system shown in FIG. 10, wherein the cup is carried by the robotic arm unit to fill ice and beverages.

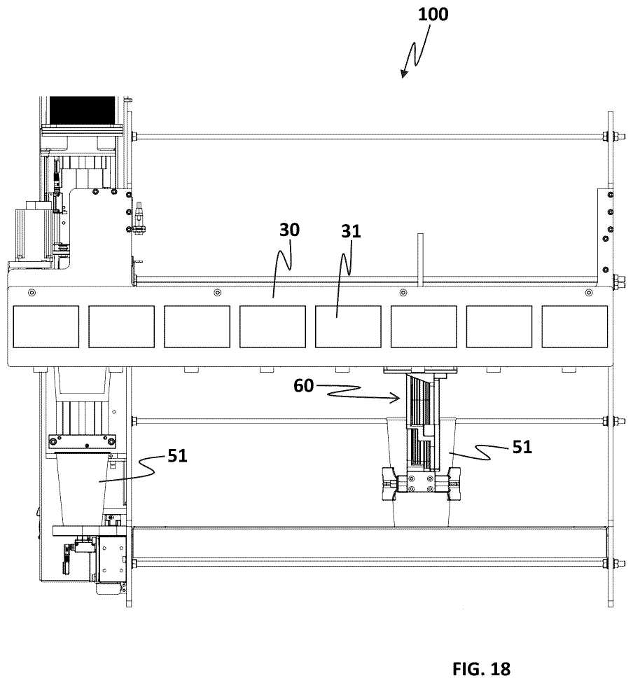

FIG. 19 is a perspective view of the automation system shown in FIG. 10, wherein the cup is pressed to the corresponding lever by the robot arm unit to receive the preselected beverage.

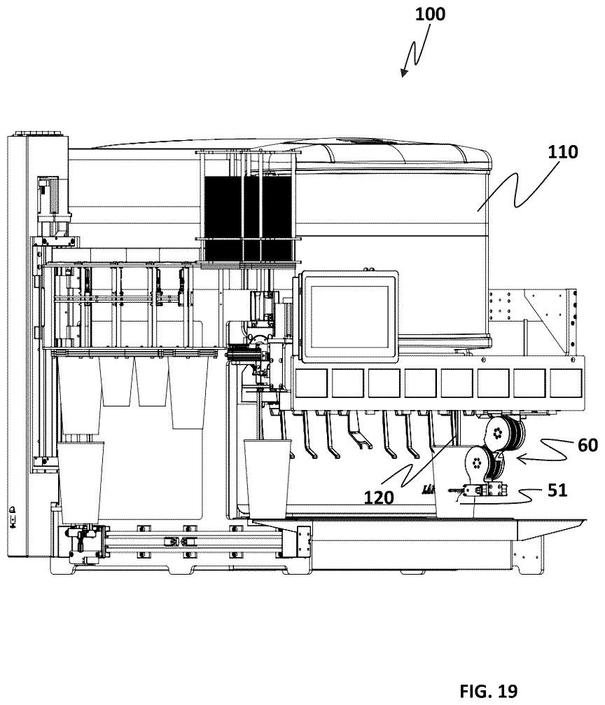

FIG. 20 is a partial side view of the automation system shown in FIG. 10, wherein the robotic arm unit holds the cup so that a lid can be attached to it.

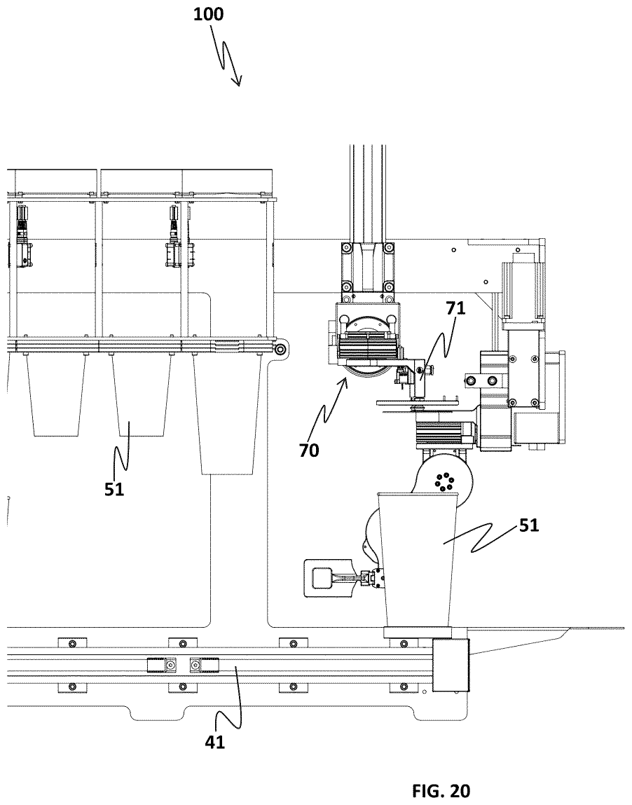

FIG. 21 is a partial side view of the automation system shown in FIG. 10, wherein the lid is attached to the cup held by the robotic arm unit.

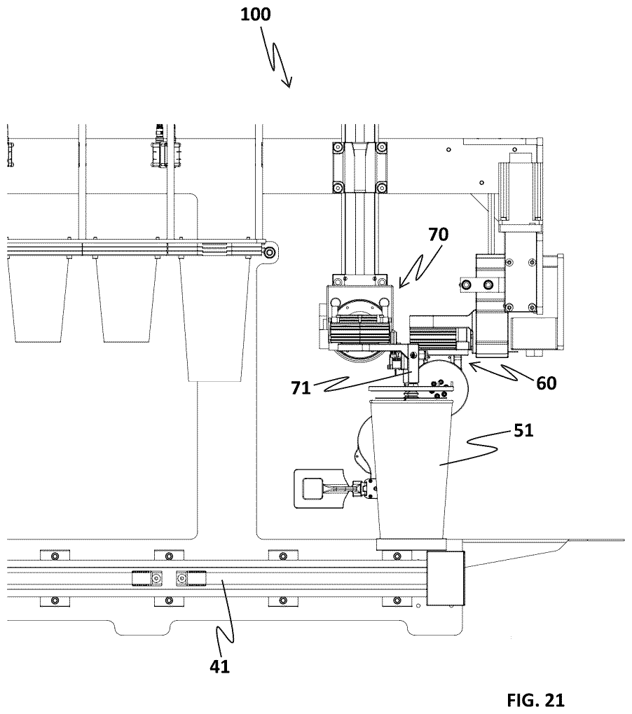

FIG. 22 is a partial side view of a lid holding unit of the automation system shown in FIG. 10.

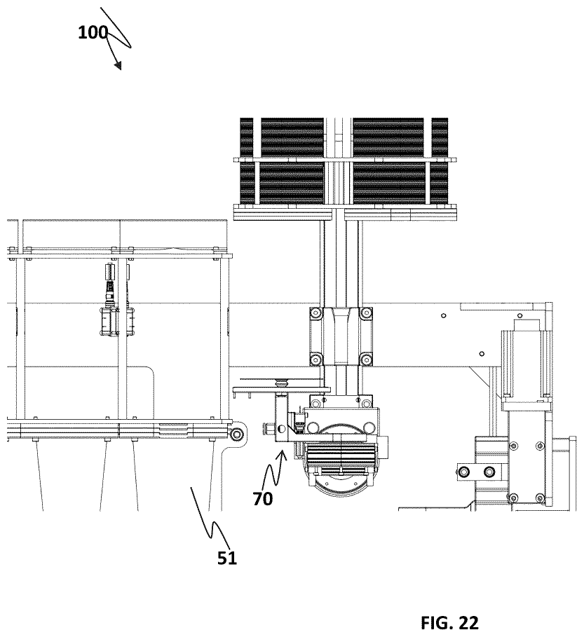

FIG. 23 is a perspective view of a second rail of the automation system shown in FIG. 10 wherein the robotic arm unit slides along the second rail.

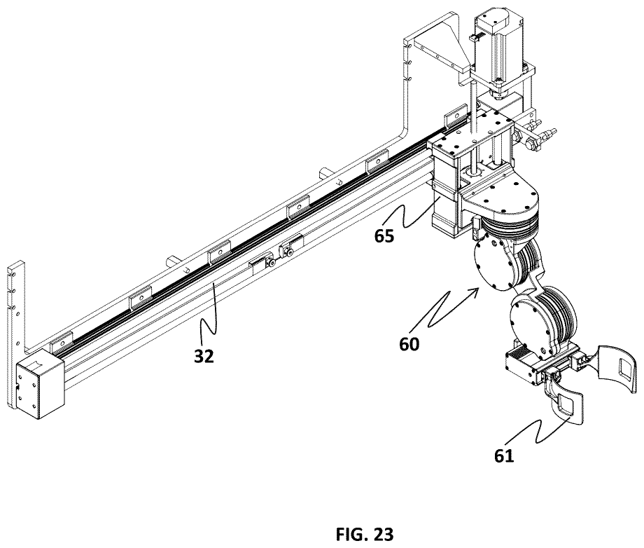

### REFERENCE NUMBERS

20. Main body
   21. Support bar
   22. Parking area
   23. Post
30. Information panel
   31. Screen
   32. Second rail
40. First slider
   41. First rail
50. Cup holding unit
   51. Cup
   52. Cup holder
   53. Third slider
60. Robotic arm unit
   61. Gripper
   62. First rotation part
63. Second rotation part
64. Third rotation part
   65. Second slider
70. Lid holding unit
   71. Attachment head
   72. Lid holder
   73. Lid
80. Touch screen
100. Automated fountain beverage dispensing system
110. Beverage dispenser
120. Lever

### DETAILED DESCRIPTION OF THE EMBODIMENTS

The following description is presented to enable any person skilled in the art to make and use the invention and is provided in the context of particular applications of the invention and their requirements. The present invention can be configured as follows:

The attachment disclosed by the present invention comprises a robotic arm.

Robotic beverage dispensers are known in the art. For example, US 2006 0043111 discloses a robotic beverage server configured to take a beverage order, prepare the beverage or mixture of beverages, and serve the beverage to a consumer. The current invention is distinguished from existing art in multiple points.

First, the current invention is not a separate beverage dispenser machine on its own. In other words, the current invention does not have a cooler, a nozzle, or other parts that exist on a conventional beverage dispenser. The current invention is an attachment that is mounted on an existing beverage dispenser. The disclosed attachment comprises a robotic arm which simulates human movement through robotic principles.

Therefore, the current invention is distinguished from U.S. Pat. No. 9,994,340 and US 2006 0043111.

Second, the current invention can close lids. In the art, closing lids is a technical problem not addressed. For example, U.S. Pat. No. 5,350,082 discloses a money-activated beverage dispensing line in which the dispensing of a beverage from a series of dispensing stations is automatically controlled with consumer interaction. On the other hand, the current invention can disclose lids because the robotic arm can simulate human movement.

Therefore, the current invention is distinguished from U.S. Pat. No. 5,350,082.

Third, the current invention follows a model and an algorithm which allows the optimization of process time. Specifically, the current invention does not comprise a carousel and on the contrary, comprises a robotic arm. This allows the current invention to deviate from first in first out and to follow a model and an algorithm. For example, US 2005 0150399 discloses a device used for automatically marking beverage containers receiving beverages from a conventional drink dispenser, comprising a carousel, which means process time cannot be optimized. In specific, the nozzle velocity is the limiting factor for process time in most instances because increased nozzle speed causes bubbling. As a result, there is an upper limit for nozzle velocity. This upper limit on nozzle velocity is generally around 4 to 5 ounces per second. The current invention can process multiple cups because the model and the algorithm followed allows the robotic arm unit to handle additional cups while one cup is being filled.

Therefore, the current invention is distinguished from US 2005 0150399. Fourth, the current attachment can be mounted or dismounted at any time. Furthermore, the current attachment may be turned off, without being dismounted, by an operator at any time, while the underlying beverage dispenser continues to be operated by a human manually.

Therefore, the current invention is distinguished from all prior art mentioned above.

The automation system in the current invention is connected to an order system of a restaurant. The automation system can be connected to the order system using any of a wired connection or a wireless connection. The order system can be any of one managed by a crew member of a restaurant or a self-serve ordering system accessible to customers of a restaurant.

As per a preferred embodiment of the present invention, the automation system comprises an order information receiving component that receives information from the order system about an order of beverages placed by a customer. The information comprises beverage details, ice requirements, and cup sizes such as child, small, medium, large, or extra-large cups (51). An order may comprise multiple beverages of different types, mixes of the beverage or flavoring (flavor shots), as well as different cup sizes for each beverage type. The order may also mention the amount of ice for each of the beverages ordered.

The disclosed robotic arm unit (60) takes a cup from an array of cups (51), stacked in separate columns as per cup sizes, corresponding to one of the cup sizes in the order placed by a customer. Cups (51) are pulled by a vacuum nozzle or by a gripper. The cups (51) are pulled down and the cup holding unit (50) is raised up after one cup (51) is extracted. The cup is moved to the robotic arm unit (60) on a linearly arranged first rail (41). Thereafter, the robotic arm unit (60) delivers the cup (51) under a lever (120) or nozzle. The robotic arm unit (60) initially fills the cup with ice, if ordered, and then beverages. Once the cup (51) has been filled with ice as per the order placed by the customer, the robotic arm unit (60) moves the cup (51) under a lever (120) or nozzle of the beverage dispenser (110). Once the cup (51) has been filled with the beverage, the robotic arm unit (60) moves the cup (51) to a lid station. In a possible embodiment, there are up to 3 sizes (i.e., small, medium, large) of lids (73) stocked upside down. The appropriate size lid (73) is pulled from the lid holding unit (70) with vacuum or mechanical action, turned and pushed down on the cup (51). Another method of closing the lid (73) is sweeping the lid (73) on the cup (51) by pulling the cup (51) under a bar. After the lid (73) is closed, the fill robotic arm unit (60) moves the cup (51) to a serving station from where the cup (51) can be collected by a customer or a crew member of the restaurant. There are displays over each cup (51) showing the order number, a color code (optionally can match vehicle color), the drink flavor, the size, and the amount of ice. In a possible embodiment, there is a light that beams color on top of the cup (51). Furthermore, this beam of color light flashes if the beverage is a diet drink, ensuring the diet drinks are properly served to potentially diabetic customers. In the parking spaces of the cups (51), sensors and LED lights recognize whether the cup (51) is there or not. The LED light preferably flashes singly on the cup (51).

There are sensors on top of the cups, sending signals to the system when each serving station is occupied or empty. The robotic arm unit (60) then delivers new orders to empty serving stations.

The present invention discloses that the automation system can be enabled to dispense, move, and fill multiple cups (51) at the same time, where each cup (51) could be of the same or different size as well as each cup may have the same or other beverage and ice requirements.

As per a preferred embodiment of the present invention, the automated fountain beverage dispensing system (100) is detachable and can be mounted to any existing beverage dispenser (110) where the various components of the automation system can be removably attached to the required components of the existing beverage dispensers (110) and the existing order system of a restaurant. It can be easily understood and appreciated by any person skilled in the art that the automated fountain beverage dispensing system (100) of the present invention can both be removably mounted to a new beverage dispensing system as well as can be made an integral part of a new beverage dispenser (110). Further, if needed, orders can be entered manually on an embedded screen on the automated fountain beverage dispensing system (100).

As per another embodiment of the present invention, the automated fountain beverage dispensing system (100) may display one or more order details on an embedded screen. The order details being displayed may include, but are not limited to, the type of drink being prepared at a moment, the number of drinks in an order, ice requirements, and cup size.

As per an embodiment of the present invention, the automation system can work in sync with the existing point-of-sale (POS) system based on the order received, where the beverage dispenser (110) is equipped to dispense ice and beverages without any manual inputs. The existing point-of-sale (POS) system can be directly integrated into the automated fountain beverage dispensing system disclosed herein.

As per another embodiment of the present invention, the automation system can work in sync with the existing point-of-sale (POS) system based on the order received, where the beverage dispenser (110) is equipped to dispense ice and beverages only with manual inputs. In such a case the automated fountain beverage dispensing system (100) would be capable of providing the manual inputs to the beverage dispensing system. In this particular case, any required manual inputs to dispense ice and/or beverages can be provided by the automation system.

It is aimed to create a full-cycle robotic system automation system that includes stages such as beverage cup selection, filling process, cap closure and then parking by integrating a robotic structure on devices that offer beverages such as Coca-Cola and Pepsi or the like through dispensers. The installation of this robotic automation system on existing dispenser machines without any physical intervention will increase operational efficiency and improve user experience.

This automation system aims to provide a hygienic solution by minimizing human interaction while ensuring the automatic preparation of beverages. In addition, the robotic system's ability to adapt to different cup sizes and perform fast filling processes will shorten users' order times and reduce waiting times. Thus, the productivity of the enterprises will increase, and faster and higher quality service will be provided to the customers. The fact that the robotic system will be installed without damaging the existing dispenser machines during installation will provide the opportunity to offer an innovative solution without creating additional costs for businesses.

In this way, customer satisfaction can be increased by providing a technological breakthrough in the beverage industry.

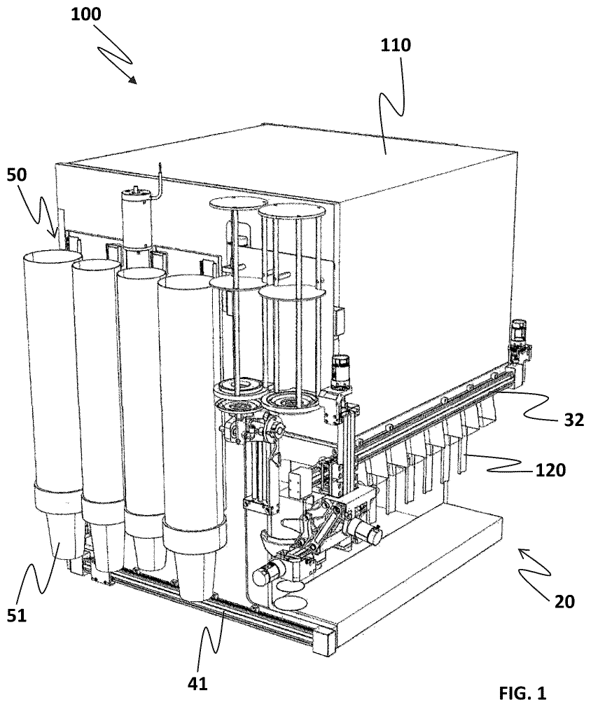

In a possible embodiment, an automated fountain beverage dispensing system (100) for a beverage dispenser (110), comprising a main body (20) attachable to the beverage dispenser (110); a cup holding unit (50) having a plurality of cup holders (52) for holding cups (51); a first rail (41) provided on the main body (20); a first slider (40) arranged to slide on the first rail (41) for extracting and moving a selected cup (51); a second rail (32) provided on the main body (20); a second slider (65) arranged to slide on the second rail (32); and a robotic arm unit (60) mounted with the second slider (65) for holding and moving the selected cup (51). Referring to FIG. 1, the cup holding unit (50) is configured to slide with respect to the first slider (40); the first slider (40) is configured to slide under a selected one of the plurality of cup holders (52) and to extract the cup (51) from the selected one of the plurality of cup holders (52) of the cup holding unit (50); the second slider (65) is configured to slide the robotic arm unit (60) to grab the cup (51) extracted and conveyed by the first slider (40); the robotic arm unit (60) is configured to fill the cup (51) with a beverage by pressing one of the plurality levers (120) of the beverage dispenser (110) depending on what type of beverage is selected from a touch screen (80) provided on the main body (20) or via a POS system; and the robotic arm unit (60) is further configured to leave the beverage filled cup (51) in a predetermined position.

The attachable main body (20) is shaped and dimensioned to attach the beverage dispenser (110) (i.e., soda fountain) which is a device that, preferably, dispenses carbonated soft drinks. When the user wants to take the desired beverage, he/she can first enter order information from the touch screen (80) provided on the main body (20) or via the POS system. The order information may comprise beverage details, ice requirements, and cup sizes such as child, small, medium, large, or extra-large cups. An order may comprise multiple beverages of different types, mixes of the beverage or flavoring (flavor shots), as well as different cup sizes for each beverage type. The order may also mention the amount of ice for each of the beverages ordered. The automated fountain beverage dispensing system (100) works as follows, it becomes active with commands from the touch screen (80), or POS system given by the user. The cup size is selected, and the cup (51) is drawn from the cup holding unit (50) by the vacuum pump provided on the first slider (40) and then conveyed to the robotic arm unit (60) on the first slider (40). The robotic arm unit (60) grasps the selected cup (51) and if the cup (51) needs to be filled with ice, the robotic arm unit (60) first goes to the ice compartment having the lever (120) assigned for ice. The robotic arm unit (60) presses the ice lever (120) with the cup then, it goes to the compartment with the desired beverage, and the filling process is carried out.

The main body (20) is configured to have a substantially rectangular cross-section which allows the beverage dispenser (110) to be deployed in it. There are openings on the lateral walls of the main body (20) and these lateral walls are supported by cylindrically shaped support bars (21). The front section of the main body (20) is provided with the second rail (32) on which the robotic arm unit (60) slides. The front section of the main body (20) is also provided with the touch screen (80) where the user can select the desired beverage. There is also an information panel (30) equipped with screens (31) throughout, which informs the user about the type/size or the like of beverage(s). The main body (20) may also have a parking area (22) having a flat surface on which the robotic arm unit (60) can deposit the beverage-filled glasses (51). The robotic arm unit (60) is configured to release the cup (51), filled with the selected beverage and fitted with the selected lid (73), into a parking area (22) formed on the main body (20).

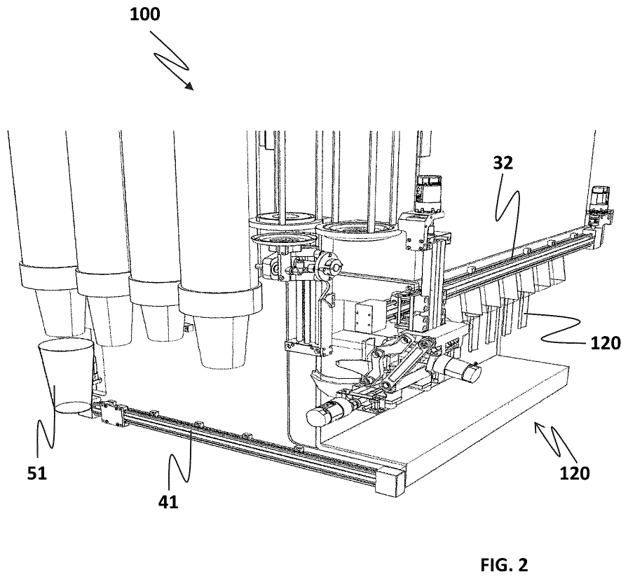

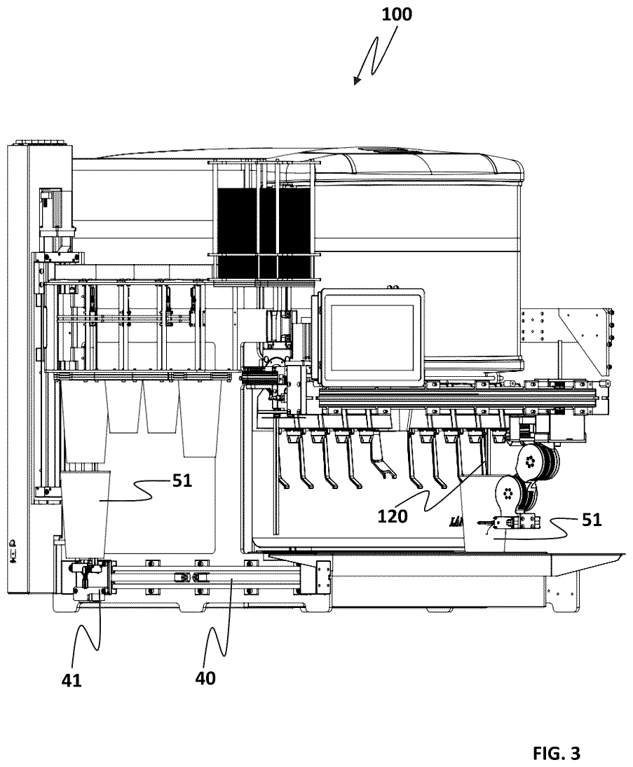

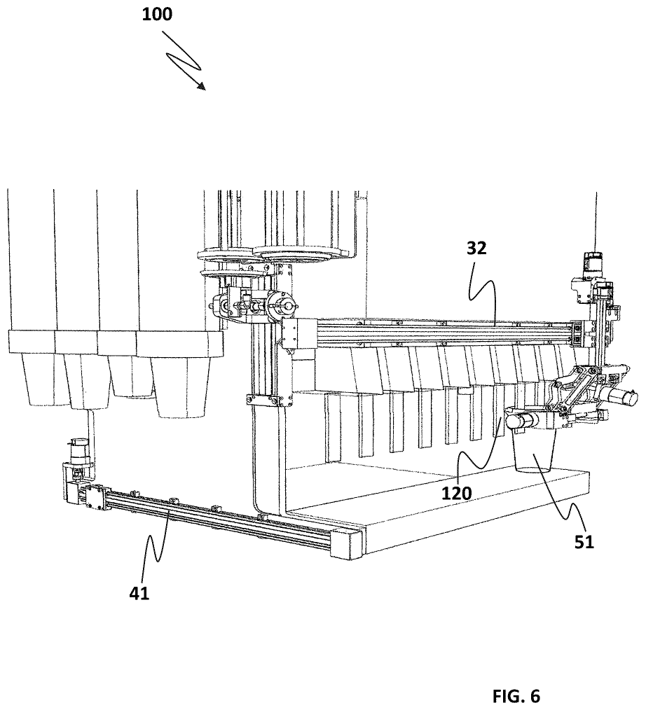

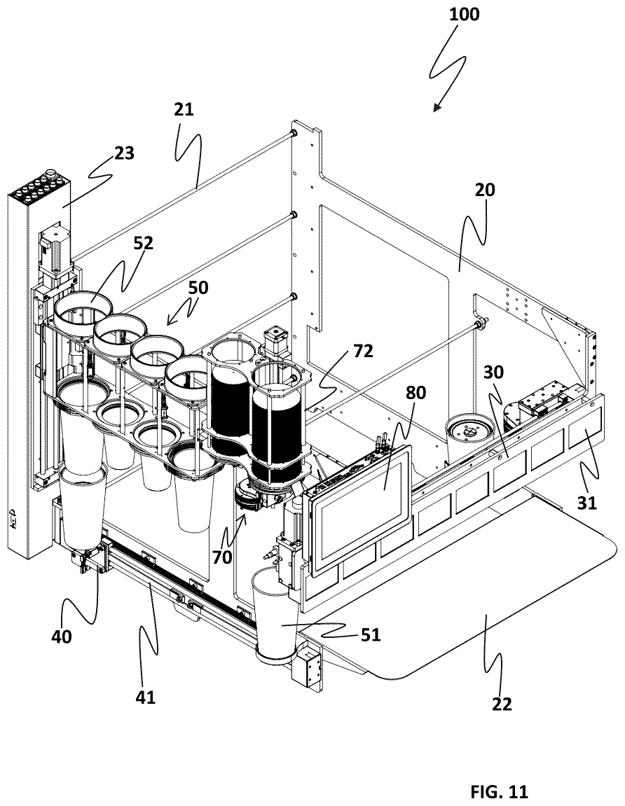

The robotic process begins after the order information has been received from the user. Referring to FIGS. 2 and 3, once the order has been received, the selected cup size is determined and the cup (51) is drawn from the cup holder unit (50) by a vacuum pump, and then transferred to the first slider (51). Referring to FIG. 6, this first slider (41) is configured to reciprocate on the first rail (41) in the direction of the longitudinal axis. The first slider (40) can have a vacuum nozzle or a gripper for pulling the predetermined cup (51) from the cup holding unit (50). The cup holding unit (50) has cup holders (52) of different sizes for holding cups (51) of different sizes and widths. The cup holder unit (50) has a third slider (53) which is movable and attached to a post (23) to move vertically. Referring to FIG. 11, the post (23) is vertically arranged as a part of the main body (20). The post (23) has embedded rails in connection with the third slider (53) which moves the cup holder unit (50) up and down. The cup holding unit (50) has a cup plate (52) having a plurality of hollow cylindrical openings of different sizes, in which cups of different sizes are held.

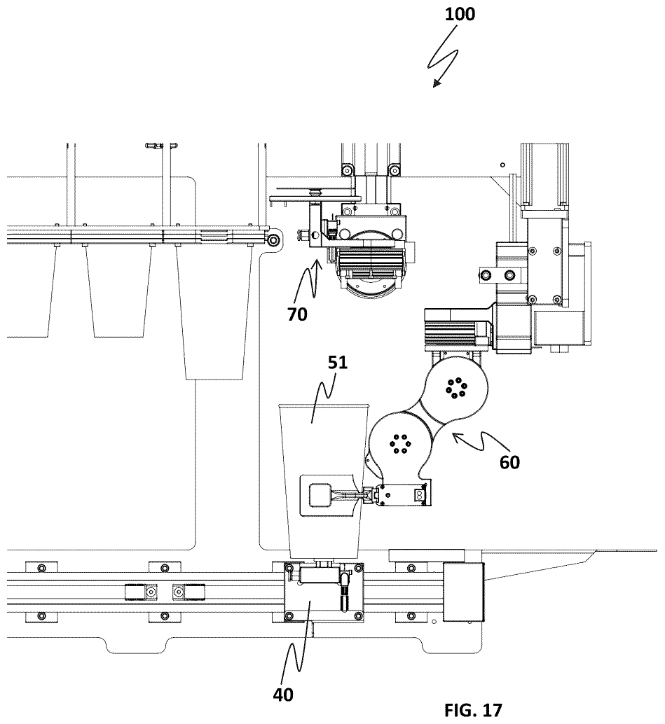

The first slider (40) is configured to slide under a selected one of the plurality of cup holders (52) and to extract the cup (51) from the selected one of the plurality of cup holders (52). After the selected cup (51) is extracted by the first slider (40), the first slider (40) holding the selected cup (51) slides along the first rail (41) (i.e., end of the first rail) to a predetermined position, as shown in FIG. 17.

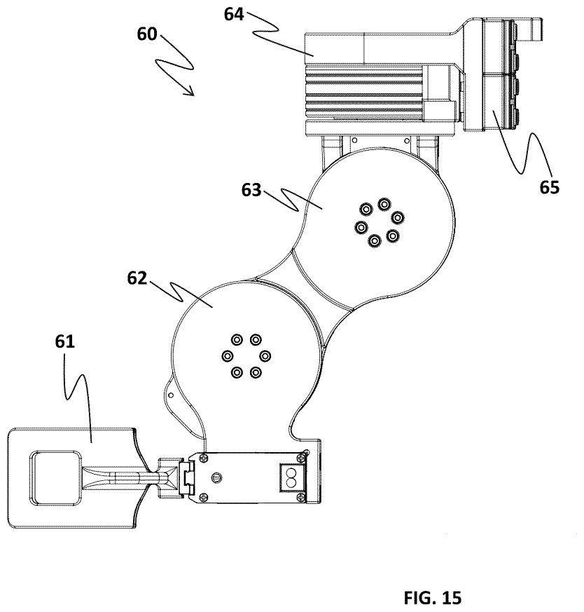

The robotic arm unit (60) has two cup grippers (61) arranged to grasp the cup (51). When the first slider (40) slides the extracted cup (51) to the predetermined position, the robotic arm unit (60) grasps the cup (51) and slides on the second rail (32) by the second slider (65). As an additional feature, the robotic arm unit (60) is configured to fill the cup (51) with ice by pressing a lever (120) assigned for ice supply in the beverage dispenser (110) before filling the cup (51) with the selected beverage wherein the amount of the ice to be served into the cup (51) can be selected from the touch screen (80) or via the POS system. The POS system may allow the business to accept payments from customers and keep track of sales. The pos system can be arranged as a self-service kiosk. The robotic arm unit is further configured to leave the beverage-filled cup in a predetermined position. The robotic arm unit (60) slides horizontally by means of the second slider (65) to an ice compartment and fills the cup (51) with ice if ice is selected by the user. Afterward, the robotic arm unit (60) holding the cup (51) goes to the selected beverage and fills the appropriate amount according to the cup size by pushing the related lever (120) of a valve of the beverage dispenser (110). During the filling process, the robotic arm unit (60), preferably, moves on 4 axes with 3 motors connected to it and with a rotation angle of 360 degrees. Referring to FIG. 15, the robotic arm unit (60) can have two cup grippers (61) arranged to grasp the cup (51), a first rotation part (62), a second rotation part (63), and a third rotation part (64). The third rotation part (64) is formed with the second slider (65) arranged to slide on the second rail (32). Referring to FIG. 25, the second slider (65) engages with the second rail (32) and slides along the longitudinal axis of the second rail (32). The robotic arm unit (60) is designed with multi-axis movement capability, incorporating several motors that enable it to rotate and move along different axes. The joints in the middle sections of the arm allow for flexible and precise movements. The grippers (61) of the robotic arm unit (60) are specifically configured to hold the cup (51). This gripping mechanism is optimized to securely grasp and transport the cup (51) and can be adjusted to grasp cups (51) of various sizes based on user needs. The robotic arm unit (60) can have two similarly shaped cup grippers (61) in the form of pincers for holding the cup (51).

After the beverage and ice filling are completed, the cup (51) is moved to the lid holding unit (70) which is also vertically movable. In the lid holding unit (70), the cup (51) is either closed with a lid (73) or optionally sealed by a sealing process. After the lid placement is completed, the cup (51) is placed in a predetermined parking position and made ready for delivery to the customer. The lid holding unit (70) has at least one lid holder (72) for holding lids (73). The lid holding unit (70) is configured to slide vertically on a part of the main body (20). The lid holding unit (70) has different types of lids (73) and lid holders (72) suitable for different size cups (51). The lid holding unit (70) has a movable lid attachment head (71) configured to hold a suitable lid (73). The lid holding unit (70) is configured to slide to the beverage-filled cup (51) grasped by the robotic arm unit (60) for placing the selected lid (73) onto the cup (51).

This system aims to increase operational efficiency and minimize human error by automating beverage filling processes. Furthermore, the CAN-bus communication system and the control card provide fast and reliable communication, thus ensuring that all processes run smoothly and synchronized.

In this application, the terminology ‘embodiment’ can be used to describe any aspect, feature, process, or step, any combination thereof, and/or any portion thereof, etc. While the invention has been described in connection with specific embodiments thereof, it will be understood that it is capable of further modifications and this application is intended to cover any variations, uses, or adaptations of the invention following, in general, the principles of the invention and including such departures from the present disclosure come within known or customary practice within the art to which the invention pertains and may be applied to the essential features herein before set forth.

Further, it will be apparent to those skilled in the art that the objects of the present invention have been achieved by providing the above invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein. Therefore, the scope of the invention is to be determined by the terminology of the above description and the legal equivalents thereof.

1. An automated fountain beverage dispensing system for a beverage dispenser, comprising:
a main body attachable to the beverage dispenser;
a cup holding unit having a plurality of cup holders for holding cups;
a first rail provided on the main body;
a first slider arranged to slide on the first rail for extracting and moving a selected cup;
a second rail provided on the main body;
a second slider arranged to slide on the second rail; and
a robotic arm unit mounted with the second slider for holding and moving the selected cup; wherein
the cup holding unit is configured to slide with respect to the first slider;
the first slider is configured to slide under a selected one of the plurality of cup holders and to extract the cup from the selected one of the plurality of cup holders of the cup holding unit;
the second slider is configured to slide the robotic arm unit to grab the cup extracted and conveyed by the first slider;
the robotic arm unit is configured to fill the cup with a beverage by pressing one of the plurality levers of the beverage dispenser depending on what type of beverage is selected from the touch screen provided on the main body or via a POS system; and
the robotic arm unit is further configured to leave the beverage-filled cup in a predetermined position.

2. The automated fountain beverage dispensing system according to claim 1, wherein the first slider has a vacuum nozzle or a gripper for pulling the predetermined cup from cup holding unit.

3. The automated fountain beverage dispensing system according to claim 1, wherein the cup holding unit has cup holders of different sizes for holding cups of different sizes and widths.

4. The automated fountain beverage dispensing system according to claim 2, wherein the cup holding unit has cup holders of different sizes for holding cups of different sizes and widths.

5. The automated fountain beverage dispensing system according to claim 1, wherein the robotic arm unit is further configured to fill the cup with ice by pressing a lever assigned for ice supply in the beverage dispenser before filling the cup with the selected beverage wherein the amount of the ice to be served into the cup is selected from a touch screen or via a POS system.

6. The automated fountain beverage dispensing system according to claim 2, wherein the robotic arm unit is further configured to fill the cup with ice by pressing a lever assigned for ice supply in the beverage dispenser before filling the cup with the selected beverage wherein the amount of the ice to be served into the cup is selected from a touch screen or via a POS system.

7. The automated fountain beverage dispensing system according to claim 3, wherein the robotic arm unit is further configured to fill the cup with ice by pressing a lever assigned for ice supply in the beverage dispenser before filling the cup with the selected beverage wherein the amount of the ice to be served into the cup is selected from a touch screen or via a POS system.

8. The automated fountain beverage dispensing system according to claim 1, wherein the automated fountain beverage dispensing system has a lid holding unit having at least one lid holder for holding lids.

9. The automated fountain beverage dispensing system according to claim 2, wherein the automated fountain beverage dispensing system has a lid holding unit having at least one lid holder for holding lids.

10. The automated fountain beverage dispensing system according to claim 3, wherein the automated fountain beverage dispensing system has a lid holding unit having at least one lid holder for holding lids.

11. The automated fountain beverage dispensing system according to claim 5, wherein the automated fountain beverage dispensing system has a lid holding unit having at least one lid holder for holding lids.

12. The automated fountain beverage dispensing system according to claim 8, wherein the lid holding unit is configured to slide vertically on a part of the main body.

13. The automated fountain beverage dispensing system according to claim 8, wherein the lid holding unit has different types of lids and lid holders suitable for different size cups.

14. The automated fountain beverage dispensing system according to claim 12, wherein the lid holding unit has different types of lids and lid holders suitable for different size cups.

15. The automated fountain beverage dispensing system according to claim 13, wherein the lid holding unit has a movable lid attachment head configured to hold a suitable lid.

16. The automated fountain beverage dispensing system according to claim 15, wherein the lid holding unit is configured to slide to the beverage-filled cup grasped by the robotic arm unit for placing the selected lid onto the cup.

17. The automated fountain beverage dispensing system according to claim 1, wherein the robotic arm unit is configured to release the cup, filled with the selected beverage and fitted with the selected lid, into a parking area formed on the main body.

18. The automated fountain beverage dispensing system according to claim 2, wherein the robotic arm unit is configured to release the cup, filled with the selected beverage and fitted with the selected lid, into a parking area formed on the main body.

19. The automated fountain beverage dispensing system according to claim 1, wherein the robotic arm unit has two similarly shaped cup grippers in the form of pincers for holding the cup.

20. The automated fountain beverage dispensing system according to claim 1, wherein the main body has an information panel equipped with a plurality of screens.
